(19) United States
(12) Patent Application Publication
(10) Pub. No.: US 2019/0112034 A1
(43) Pub. Date: Apr. 18, 2019

(54) AIRCRAFT LANDING GEAR BAY ROOF COMPRISING AN INCLINED AFT BULKHEAD

(71) Applicants: Airbus Operations SAS, Toulouse (FR); Stelia Aerospace, Rochefort (FR)

(72) Inventors: Daniel BELLET, SAINT-LYS (FR); Francois LOYANT, L'ISLE JOURDAIN (FR); Alexandre LEGARDEZ, CLERMONT SAVES (FR); Simon ROUX, TOULOUSE (FR); Sebastien CROUZET, TOULOUSE (FR); Laurent DUBREUIL, PIBRAC (FR); Alain PRUDENT, MONTBRUN LAURAGAIS (FR)

(21) Appl. No.: 16/161,461

(22) Filed: Oct. 16, 2018

(30) Foreign Application Priority Data
Oct. 17, 2017 (FR) 1759720

(51) Int. Cl. B64C 25/00; B64C 25/16

(52) U.S. Cl. CPC B64C 25/001; B64C 25/16

(57) ABSTRACT

An aircraft landing gear bay roof for forming a pressurization barrier between an upper pressurized compartment and a landing gear bay for the housing of a landing gear. The roof comprises a main bulkhead extending in a longitudinal direction, an inclined forward bulkhead, rigidly connected to a forward edge of the main wall, and an inclined aft bulkhead, rigidly connected to an aft edge of the main bulkhead. The forward bulkhead and the aft bulkhead each form an obtuse angle with the main bulkhead. This configuration enables a better absorption of loads by the landing gear bay roof and a shorter and optimized path for transmission of the mechanical loads, in particular to the fuselage member to which the aft bulkhead is configured to be connected.

### CROSS-REFERENCES TO RELATED APPLICATIONS

This application claims the benefit of the French patent application No. 1759720 filed on Oct. 17, 2017, the entire disclosures of which are incorporated herein by way of reference.

### BACKGROUND OF THE INVENTION

The present invention relates to the structure of aircraft, in particular in their landing gear. It relates, in particular, to a main landing gear bay, and relates more specifically to the roof of such a landing gear bay.

In most aircraft known from the state of the art, in particular commercial passenger or merchandise transport aircraft, the main landing gear bay is formed under the fuselage of the aircraft, at a longitudinal position situated in proximity to the trailing edge of the main wing of the aircraft.

The main gear bay roof is intended firstly to ensure the separation between the pressurized upper compartment and the lower compartment forming the landing gear bay for the housing of the main landing gear.

This non-pressurized landing gear bay is delimited to the front by a central wing box and to the rear by the baggage hold.

The landing gear bay roof is generally connected to the upper panel of the central wing box. Because of this, the bay roof must withstand the deformations of the central wing box. Thus, the landing gear bay roof must be sufficiently flexible in the transverse direction of the aircraft to limit the negative consequences of these deformations.

Furthermore, some main landing gear configurations developed in recent years require the mechanical forces to which the gear is subjected to be taken up no longer only by the wing structure, but also by the fuselage of the aircraft.

Also, a landing gear bay configuration with flexible roof can prove inappropriate when the roof has to take up mechanical forces originating directly from structural elements of the landing gear, like the strut.

In response to this issue, the document FR3031080 discloses a main landing gear bay comprising a roof comprising a first and a second reinforced structure, spaced apart from one another in a transverse direction of the roof, and a membrane linking the first and the second reinforced structure. According to this configuration, the first and the second reinforced structure allow the forces imposed by a structural element of a landing gear which is respectively linked to them to be taken up, and this force to be transmitted to the structure of the fuselage, while the membrane allows the deformations provoked by the central wing box.

Nevertheless, this configuration, although it allows the forces to be taken up by the landing gear bay, is not optimized with respect to the routing of the forces in the structure of the landing gear bay and to the structure of the fuselage.

The aim of the present invention is thus to propose a main aircraft landing gear bay roof configuration that wholly or partly resolves this issue.

Thus, the invention relates to a main landing gear bay roof for aircraft, the roof being intended to form a pressurization barrier between a pressurized upper compartment and a landing gear bay for the housing of a landing gear. The roof comprises:

a main bulkhead extending in a longitudinal direction and comprising a front edge and a rear edge,

an inclined front bulkhead, rigidly linked to the front edge of the main bulkhead, and forming an obtuse angle with the main bulkhead.

The landing gear bay roof comprises an inclined rear bulkhead, rigidly linked to the rear edge of the main bulkhead, and forming an obtuse angle with the main bulkhead.

The landing gear bay roof thus has a “bridge” configuration formed by the main bulkhead and the inclined front and rear bulkheads. This configuration allows for a better take-up of forces by the landing gear bay roof and a shorter and optimized pathway for transmission of the mechanical forces, in particular to the fuselage element to which the rear bulkhead is intended to be linked. This configuration also offers an optimized distribution of the mechanical forces due to the pressurization of the cockpit of the aircraft that the landing gear bay roof separates from the non-pressurized landing gear bay.

The angle formed between the main bulkhead and the rear bulkhead can lie between 100° and 170°, and, in particular, between 120° and 170°. It can, in particular, lie between 130° and 160°. It can, for example, be of the order of 150° or 160°.

An angle of such a value makes it possible to obtain a gentle slope, which makes it possible to envelope the landing gear contained in the landing gear bay, while making it possible to save space outside of the bay compared to a bay comprising a conventional roof.

The angle formed between the main bulkhead and the rear bulkhead, on the one hand, and the angle formed between the main bulkhead and the front bulkhead, on the other hand, are substantially equal.

The main, front and rear bulkheads of the roof can form a first and a second lateral reinforced structure, spaced apart from one another in a transverse direction of the roof and being equipped respectively with mounting means allowing the articulation of a structural element of a landing gear, and a deformable part linking the first and the second reinforced structure by being interposed between the latter. The deformable part comprises several sets of membranes linking the first and second reinforced structures, abutted transversely between the first reinforced structure and the second reinforced structure.

For example, the deformable part is held:
on either side by lateral gantries configured to be positioned outside of the landing gear bay;
between each set of membranes by central gantries configured to be situated in the landing gear bay and molding to the form of the front, main and rear walls of the landing gear bay roof.

The invention relates also to a main landing gear bay, delimited between:
a front wall of the landing gear bay;
a substantially vertical rigid wall forming the rear wall of the landing gear bay, and
a landing gear bay roof as previously described, the front bulkhead of which is linked to the front wall of the landing gear bay, and the rear bulkhead of which is linked to the rigid wall.

Such a landing gear bay can further comprise at least one main aircraft landing gear comprising a structural element linked to the landing gear bay roof.

The invention relates also to an assembly comprising such a landing gear bay, further comprising a central wing box intended for the connection of two wings respectively on either side thereof in the transverse direction, in which the front wall of the landing gear bay is formed by a rear wall of the central box.

The invention relates finally to an aircraft comprising such an assembly.

### BRIEF DESCRIPTION OF THE DRAWINGS

Other particular features and advantages of the invention will become more apparent from the following description.

In the attached drawings, given as non-limiting examples:

FIG. 1 represents an exploded schematic view of an aircraft that can be the subject of the invention;

FIG. 2 represents, by a three-dimensional schematic view, a section of aircraft fuselage that can be the subject of the invention;

FIG. 3 represents, by a cross-sectional schematic view, a section of aircraft fuselage according to the state of the art;

FIG. 4 represents, by a view similar to that of FIG. 3, a section of aircraft fuselage comprising a landing gear bay roof according to an embodiment of the invention;

FIG. 5 represents, by a three-dimensional schematic diagram, a landing gear bay roof according to an embodiment of the invention;

FIG. 6 represents, by a three-dimensional view, a landing gear bay roof according to an embodiment of the invention and its immediate environment when it is installed in an aircraft.

### DETAILED DESCRIPTION OF THE PREFERRED EMBODIMENTS

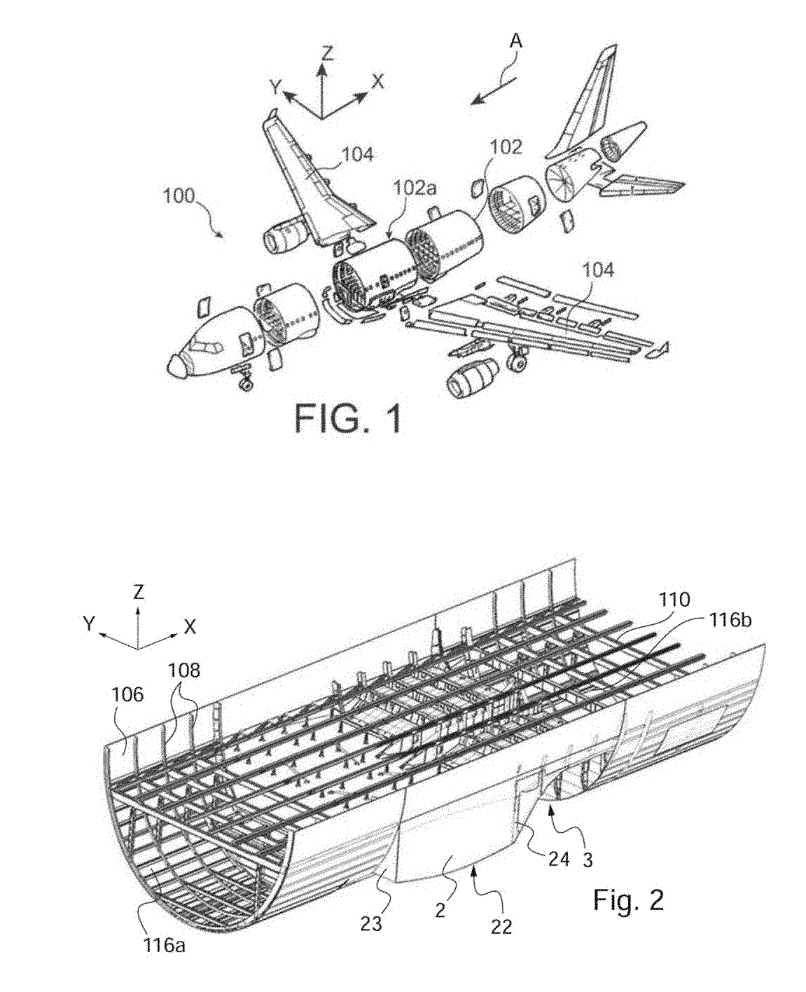

Referring to FIG. 1, an aircraft 100 is represented, in this case of commercial airplane type.

Throughout the following description, by convention, X corresponds to the longitudinal direction of the aircraft, Y to the transverse direction, oriented transversely relative to the longitudinal axis, and Z to the vertical or heightwise direction, these three directions X, Y and Z being mutually orthogonal.

Also, the terms “front” and “rear” are to be considered relative to a direction of advance of the aircraft in flight, this direction being represented schematically by the arrow A.

The aircraft 100 comprises a fuselage 102 to which are attached two wings 104, at a fuselage section 102a.

The fuselage section 102a is specific to the invention, in that it comprises a landing gear bay provided with a landing gear bay roof according to the invention.

This fuselage section 102a is represented in more detail in FIG. 2. It comprises an outer fuselage skin 106, supported by substantially circular or elliptical fuselage frames 108. In the section 102a, a floor 110 is provided, above which is arranged a pressurized upper compartment, namely the passenger cabin 112 of the aircraft.

Under the floor 110, at the front of this section 102a, there is provided a first underfloor pressurized compartment 116a usually dedicated to the storage of technical equipment specific to the aircraft, and/or to the storage of a payload.

The underfloor compartment 116a is delimited to the rear by a central wing box 2, also arranged under the floor 110. The central wing box 2 extends transversely across the entire width of the fuselage section 102a. It conventionally has an upper skin 21, a lower wall 22, a front wall 23, a rear wall 24, and lateral closure panels as well as internal rigidifying ribs. It is intended for the connection of the two wings 104, respectively on either side thereof in the transverse direction Y.

To the rear, the section 102a has a landing gear bay 3 for the housing of the two main landing gears, spaced apart from one another in the transverse direction Y.

The landing gear bay 3 is delimited to the front by the rear wall of the central wing box 2 incorporated in the section 102a. The rear wall 24 thus forms a front wall of the landing gear bay.

The fuselage has, in the bottom part of the landing gear bay 3, a downward opening allowing the landing gears to be raised and lowered, the opening being blocked by mobile hatches reconstructing the fuselage in the retracted position of the gear.

To the rear, the landing gear bay 3 is delimited by a substantially vertical rigid wall 31, separating the landing gear bay 3 from a second underfloor compartment 116b, also dedicated to the storage of technical equipment and/or to the storage of the payload.

At the top, the landing gear bay 3 is delimited by a landing gear bay roof 4 extending across the entire transverse width of the fuselage section 102a in which it is incorporated.

The roof 4, specific to the invention, is situated under the floor 110.

It is noted that, above this roof 4 which forms a pressurization barrier, there is provided a pressurized intermediate compartment delimited between the floor 110 and this same roof 4. For the purposes of simplification of the figures, the cabin for the passengers and this pressurized intermediate compartment are associated with the same numeric reference 112. It therefore constitutes a pressurization barrier between the pressurized cabin 112 situated above this roof, and the non-pressurized landing gear bay 3 housing the main landing gears.

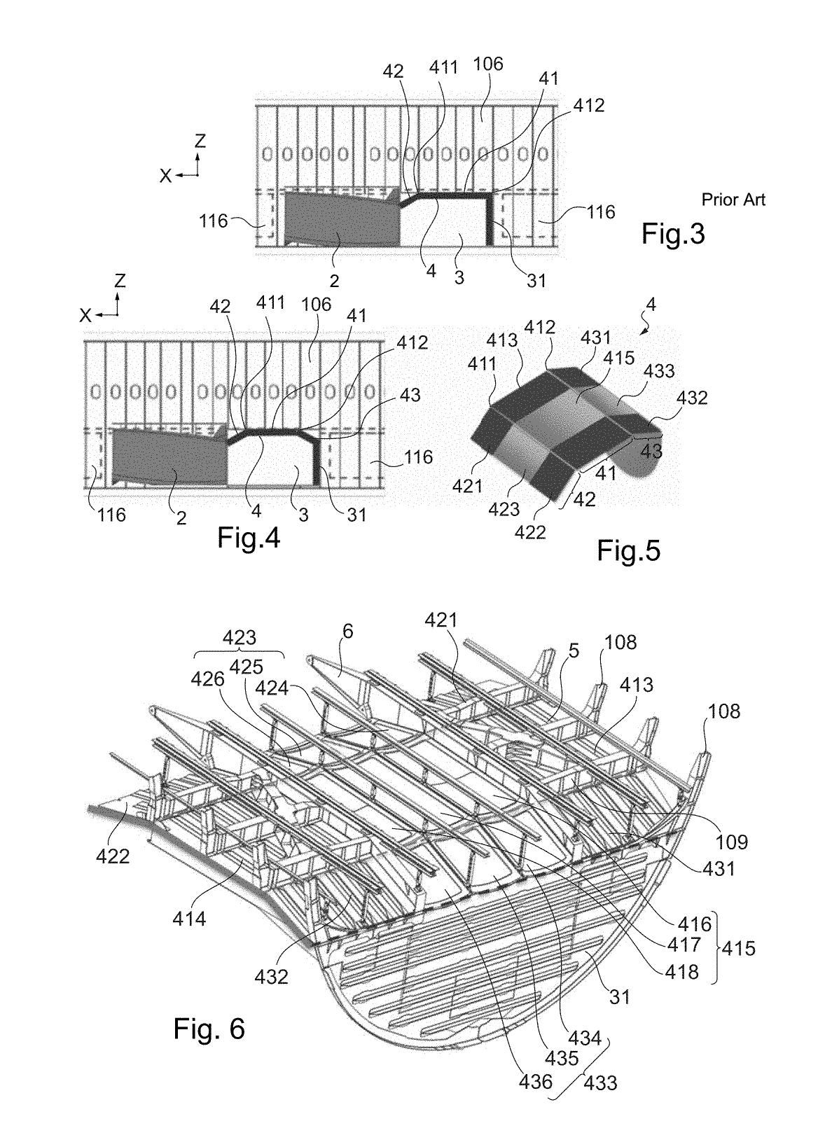

FIG. 3 schematically represents a landing gear bay 3 and its immediate environment, according to an embodiment according to the state of the art, for example according to the document FR3031080. The section 102a therein is seen from the side, by a median longitudinal cross section.

The landing gear bay roof 4 known from the state of the art comprises, longitudinally, essentially two parts. The roof 4 thus comprises a main bulkhead 41 extending in a longitudinal direction. The main bulkhead 41 is substantially horizontal, that is to say in a plane parallel to the longitudinal direction X and to the transverse direction Y, and orthogonal to the vertical direction Z.

The roof 4 further comprises a front bulkhead 42, which is inclined relative to the main bulkhead 41. The front bulkhead 42 is linked rigidly to the front edge 411 of the main bulkhead 41, the front edge 411 extending substantially in the transverse direction Y.

The term inclined means that the front bulkhead 42 forms an angle with respect to the main bulkhead 41, but without being orthogonal thereto. The front bulkhead 42 nevertheless remains parallel or substantially parallel to the transverse axis Y. The angle formed between the main bulkhead 41 and the front bulkhead 42, measured inside the landing gear bay 3, is an obtuse angle. An obtuse angle denotes an angle strictly greater than 90° and strictly less than 180°. This angle can lie between 110° and 170°. For example, this angle can lie between 120° and 170°, in particular 150° or approximately (+/−5%) 150°, or 160° or approximately 160°.

The front bulkhead 42 allows the landing gear bay 3 roof to be linked to the central wing box 2, in the top part of the rear wall 24. Indeed, because of the configuration of the wing, in particular its profile, the top edge of the rear wall is at a level lower than the plane of extension of the main bulkhead 41 of the roof 4.

The main part 41 is linked, at its rear edge 412 which extends substantially in the transverse direction Y, to the rigid wall 31 which forms the rear wall of the landing gear bay 3.

FIG. 4 illustrates, by a view similar to that of FIG. 3, a landing gear bay roof 4 according to an embodiment of the invention. The roof 4 comprises, compared to the roof of FIG. 3, an inclined rear bulkhead 43 rigidly linked to the rear edge 412 of the main bulkhead 41.

The angle formed between the main bulkhead 41 and the rear bulkhead 43, measured inside the landing gear bay 3, is an obtuse angle. This angle can lie between 110° and 170°. For example, this angle can lie between 120° and 170°, in particular 150° or approximately 150°, or 160° or approximately 160°. The angle between the main bulkhead 41 and the front bulkhead 42 on the one hand, and the angle between the main bulkhead 41 and the rear bulkhead 43 on the other hand, can be equal.

The landing gear bay roof 4 according to the invention thus has a general so-called “bridge” form, because it evokes the form of a bridge with a rising first part, a planar horizontal part, and a descending part.

This bridge form offers numerous advantages. The transmission of the forces transmitted to the roof 4 by a landing gear which is linked thereto is optimized, particularly in the rear part of the landing gear bay 3, for example to the rigid wall 31. Furthermore, the resistance to the forces linked to the difference of pressure between the cabin 112 which is pressurized and the landing gear bay 3 which is not is enhanced. The fact that the rigid bulkhead 31 is shortened heightwise clears, above this rigid bulkhead 31, a space which facilitates the running of systems of the aircraft, for example pipelines and/or cables, above the landing gear bay 3.

An embodiment of the invention will be described hereinbelow with reference to FIGS. 5 and 6 in which the roof 4 of the landing gear bay 3 has, transversely, a particular construction.

FIG. 5 describes the construction of the roof 4. FIG. 6 presents an example of integration of the landing gear bay roof 4 in its immediate environment.

The substantially horizontal main bulkhead 41 comprises, transversely in the example represented here, two rigid lateral zones 413, 414, and a flexible central zone 415.

Each of the lateral zones 413, 414 comprises:
a self-stiffened panel 5, made of metal or of composite material. The self-stiffened panel 5 is located between several inter-frame spaces, that is to say that it extends longitudinally between several frames 108 of the fuselage section;
a bridge-form lateral gantry 6, which extends longitudinally also at the level of the front and rear bulkheads described hereinbelow, interfaced with the respective feet 109 of the frames 108 between which the self-stiffened panel extends;
a main gear strut take-up fitting situated under the panel, or other mounting means allowing the articulation of a structural element of a landing gear;
a longitudinal beam linked to the take-up fitting, allowing a transfer of the forces to the frame feet 109 and to the lateral gantry 6.

The central zone 415 of the main bulkhead 41 extends between the lateral gantries 6. The central zone 415 comprises one or more flexible membranes. In the example represented here, the central zone 415 comprises three membranes 416, 417, 418. Between each membrane there is positioned a central gantry, which extends longitudinally under the membranes, that is to say in the landing gear bay 3.

The central gantries extend longitudinally also at the level of the front and rear parts of the landing gear bay roof 4, and mold to the internal form of the roof 4. The central gantries can thus have a “bridge” form. Links by beams called intercostal beams are produced between the central gantries in order to stabilize them.

The front bulkhead 42, inclined relative to the main bulkhead 41 (for example by 110° to 170° of angle measured from the interior of the landing gear bay), comprises, transversely in the example represented here, two rigid lateral zones 421, 422, and a flexible central zone 423.

The front bulkhead 42 is delimited at the front by the upper surface panel of the central wing box 2, and at the rear by a frame foot 109 which ensures the junction with the front edge 411 of the main bulkhead 41.

At the front, the link between the front bulkhead 42 and the central wing box 2 can be wholly or partly a pivot link of transverse axis.

In particular, in the example represented here, the central gantries are linked by pivot to the central wing box 2, whereas the lateral gantries 6 are rigidly linked thereto. In effect, the consequences of the flexural moment of the central wing box 2 are greater on the deformable central part than on the rigid lateral parts. The transfer of this flexural moment is not however desirable.

The two lateral zones 421, 422 of the front bulkhead 42 each comprise a self-stiffened panel made of metal or of composite material. The self-stiffened panel is, in the example represented here, located between two frames 108. The lateral gantry 6 described hereinabove extends at the level of the front bulkhead 42, above the latter.

The central zone 423 of the front bulkhead 42 extends between the lateral gantries 6. The central zone 423 of the front bulkhead 42 comprises one or more flexible membranes. In the example represented here, the central zone 423 comprises three membranes 424, 425, 426. The central gantries described previously extend between the membranes 424, 425, 426, under the latter, by molding to the internal form of the roof 4.

The rear bulkhead 43, inclined relative to the main bulkhead 41 (for example by 100° to 170° of angle, measured from the interior of the landing gear bay), comprises, transversely in the example represented here, two rigid lateral zones 431, 432, and a flexible central zone 433.

The rear bulkhead 43 is delimited at the front by a frame foot 109 which ensures the junction with the rear edge 412 of the main bulkhead 41, and at the rear by the rigid wall 31.

The two lateral zones 431, 432 of the rear bulkhead 43 each comprise a self-stiffened panel made of metal or of composite material. The self-stiffened panel is, in the example represented here, located between two frames 108. The lateral gantry 6 described hereinabove extends at the level of the rear bulkhead 43, above the latter.

The central zone 433 of the rear bulkhead 43 extends between the lateral gantries 6. The central zone 433 of the rear bulkhead 43 comprises one or more flexible membranes. In the example represented here, the central zone 433 comprises three membranes 434, 435, 436. The central gantries described previously extend between the membranes 434, 435, 436, under the latter, by molding to the internal form of the roof 4.

Thus, the landing gear bay roof 4 can be considered according to its segmentation into three longitudinally abutted walls, namely the front wall 42, the main wall 41 and the rear wall 43.

The roof 4 can also be considered according to its transverse segmentation, according to which the roof comprises a first and a second lateral reinforced structure, composed of the lateral zones of the walls (main, front and rear) of the roof 4, and a deformable part interposed between the lateral reinforced structures composed of the central zones of the walls (main, front and rear) of the roof 4. The first lateral reinforced structure comprises the lateral zones referenced 421, 413 and 431. The second lateral structure comprises the lateral zones referenced 422, 414 and 432. The deformable part comprises the central zones referenced 415, 423 and 433.

In considering the transverse segmentation of the roof 4, the deformable part comprises, for each wall of the roof 4, three sets of membranes linking the first and the second reinforced structures transversely abutted between the first and the second reinforced structures. According to alternative embodiments, the deformable part can be composed of one, two, four or five sets of membranes.

Very obviously, many features of the invention described by way of example hereinabove can be produced in various ways without departing from the scope of the invention.

The membranes can be made of metal or produced in a material based on an elastomer. The membranes advantageously have a rounded form according to a transverse curvature. That allows for a better control of the deformation thereof and offers a volume allowing the running of systems of the aircraft. In particular, it is possible to run pipelines (of hydraulic systems, electrical cables, etc.) in the longitudinal hollow formed by the curvature of the membranes.

The self-stiffened panels can be replaced by simple panels, of sufficient rigidity, for example panels on which stiffeners have been added. That is the case whether the panels are made of metal or of composite material.

The invention thus developed offers a landing gear bay roof for aircraft which has an optimized configuration. In particular, the “bridge” configuration of the roof, by virtue of the inclined front and rear bulkheads, allows for a better take-up of the mechanical forces which are transmitted by the landing gear, in particular to the rear of the landing gear bay. Furthermore, the roof has a better resistance to the forces linked to the pressure difference below and above the roof, and allows for an easier running of cables, pipelines and other systems of the aircraft equipped with the landing gear bay roof.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A main landing gear bay roof for aircraft, said roof configured to form a pressurization barrier between a pressurized upper compartment and a landing gear bay for housing a landing gear, said roof comprising:
a main bulkhead extending in a longitudinal direction and comprising a front edge and a rear edge,
an inclined front bulkhead, rigidly linked to the front edge of the main bulkhead, and forming an obtuse angle with the main bulkhead,
the landing gear bay roof comprising an inclined rear bulkhead, rigidly linked to the rear edge of the main bulkhead, and forming an obtuse angle with the main bulkhead.

2. The landing gear bay roof according to claim 1, in which the angle formed between the main bulkhead and the rear bulkhead lies between 120° and 170°.

3. The landing gear bay roof according to claim 2, in which the angle formed between the main bulkhead and the rear bulkhead lies between 130° and 160°.

4. The landing gear bay roof according to claim 3, in which the angle formed between the main bulkhead and the rear bulkhead is approximately 150°.

5. The landing gear bay roof according to claim 1, wherein the angle formed between the main bulkhead and the rear bulkhead, and the angle formed between the main bulkhead and the front bulkhead, are substantially equal.

6. The landing gear bay roof according to claim 1, wherein the main, front and rear bulkheads of the roof form a first and a second lateral reinforced structure, spaced apart from one another in a transverse direction of the roof and being equipped respectively with mounting means allowing articulation of a structural element of a landing gear, and a deformable part linking the first and the second lateral reinforced structure by being interposed between the first and the second lateral reinforced structure.

7. The landing gear bay roof according to claim 6, wherein the deformable part comprises several sets of membranes linking the first and second lateral reinforced structures, abutted transversely between the first lateral reinforced structure and the second lateral reinforced structure, and is held:
on either side by lateral gantries configured to be positioned outside of the landing gear bay;
between each set of membranes by central gantries configured to be situated in the landing gear bay and molding to the form of the front, main and rear walls of the landing gear bay roof.

8. A main landing gear bay delimited between:
a front wall of the main landing gear bay;
a substantially vertical rigid wall forming a rear wall of the main landing gear bay, and
a landing gear bay roof according to claim 1, the front bulkhead of which is linked to said front wall of the landing gear bay, and the rear bulkhead of which is linked to said rigid wall.

9. The main landing gear bay according to claim 8, further comprising at least one main aircraft landing gear comprising a structural element linked to the landing gear bay roof.

10. An assembly comprising a landing gear bay according to claim 8, further comprising a central wing box, configured for a connection of two wings respectively on either side thereof in a transverse direction, in which the front wall of the landing gear bay is formed by a rear wall of the central box.

11. An aircraft comprising a landing gear bay according to claim 8.

12. An aircraft comprising an assembly according to claim 10.
